(19) United States
(12) Patent Application Publication
(10) Pub. No.: US 2026/0201868 A1
(43) Pub. Date: Jul. 16, 2026

(54) LIGHTNING PROTECTION SYSTEM FOR A WIND TURBINE ROTOR BLADE

(71) Applicants: Richard Allen HARDISON, Greensville, SC (US); LM Wind Power A/S, Kolding (DK)

(72) Inventors: Antonio Andrea Maria Laudani, Southampton (GB); Richard Allen Hardison, Greenville, SC (US)

(21) Appl. No.: 19/131,307

(22) PCT Filed: Nov. 23, 2022
(86) PCT No.: PCT/US2022/050825

§ 371 Date: May 20, 2025

(51) Int. Cl. F03D 80/30; F03D 1/06; F03D 13/10

(52) U.S. Cl. CPC F03D 80/301; F03D 1/0677; F03D 13/10; F05B 2230/60; F05B 2240/302

(57) ABSTRACT

A rotor blade assembly includes a first blade segment and a second blade segment extending in opposite directions from a chord-wise joint. Each of the first and second blade segments includes at least one shell member defining an airfoil surface and an internal support structure. The internal support structure of the first blade segment includes a beam structure extending lengthwise that structurally connects with the internal support structure of the second blade segment via a receiving section. The rotor blade assembly also includes a lightning protection system having a first conductive cage integrated with the beam structure and a second conductive cage integrated with the receiving section and electrically connected to the first conductive cage via an electrical connection. Further, the first and second conductive cages are grounded.

### FIELD

The present disclosure relates in general to wind turbine rotor blades, and more particularly to a lightning protection system for a wind turbine rotor blade.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Wind turbine rotor blades generally include a body shell formed of a composite laminate material. In general, the body shell is relatively lightweight and has structural properties (e.g., stiffness, buckling resistance and strength) which are not configured to withstand the bending moments and other loads exerted on the rotor bade during operation. To increase the stiffness, buckling resistance and strength of the rotor blade, the body shell is typically reinforced using spar caps that engage the inner surfaces of the shell. The spar caps may be constructed of various materials, including but not limited to glass fiber laminate composites and/or carbon fiber laminate composites.

During the life of the wind turbine, the rotor blades are particularly prone to lightning strikes. In particular, when carbon fibers are used in the body shell, lightning may attach to these fibers, thereby causing severe damage to the body shell. Thus, lightning protection systems are essential to protecting wind turbine blades because of their sharp edges and insulation capabilities. Modern lightning protection system typically include one or more lightning receptors disposed on the exterior of the rotor blades and a lightning conductor or cable wire coupled to the lightning receptor(s) and extending through the body shell from a blade tip to a blade root and through other components until grounded down through the tower to a ground location. Accordingly, when lightning strikes the rotor blade, the electrical current flows through the lightning receptor(s) and is conducted through the lightning system to the ground. However, when a lightning strike occurs, unwanted internal arcs may arise from the spar caps to the lightning conductor, which may cause significant damage to the rotor blade.

Accordingly, the art is continuously seeking new and improved lightning protection systems for wind turbine rotor blades.

### BRIEF DESCRIPTION

Aspects and advantages of the invention will be set forth in part in the following description, or may be obvious from the description, or may be learned through practice of the invention.

In an aspect, the present disclosure is directed to a rotor blade assembly. The rotor blade assembly includes a first blade segment and a second blade segment extending in opposite directions from a chord-wise joint. Each of the first and second blade segments includes at least one shell member defining an airfoil surface and an internal support structure. The internal support structure of the first blade segment includes a beam structure extending lengthwise that structurally connects with the internal support structure of the second blade segment via a receiving section. The rotor blade assembly includes a lightning protection system having a first conductive cage integrated with the beam structure and a second conductive cage integrated with the receiving section and electrically connected to the first conductive cage via an electrical connection, the first and second conductive cages being grounded.

In another aspect, the present disclosure is directed to a method of assembling a rotor blade of a wind turbine. The method includes providing a first blade segment and a second blade segment. Each of the first and second blade segments have at least one shell member defining an airfoil surface and an internal support structure. The internal support structure of the first blade segment includes a beam structure extending lengthwise that structurally connects with the internal support structure of the second blade segment via a receiving section. The method also includes integrating a first conductive cage with the beam structure and integrating a second conductive cage with the receiving section. Further, the method includes electrically connecting the first conductive cage to the second conductive cage via an electrical connection. Moreover, the method includes electrically connecting the first and second conductive cages to ground. In addition, the method includes arranging the first blade segment with the second blade segment in opposite directions from a chord-wise joint and securing the first and second blade segments together.

In yet another aspect, the present disclosure is directed to a rotor blade assembly having at least one blade segment with at least one shell member defining an airfoil surface and an internal support structure. The internal support structure includes a spar structure extending lengthwise. The spar structure includes an upper conductive beam and a lower conductive beam integrated therein. The upper and lower conductive beams each define a perimeter. The rotor blade assembly further includes a lightning protection system having a conductive cage integrated with the spar structure. The conductive cage surrounds only a portion of the perimeters of each of the upper and lower conductive beams. Further, the lightning protection system includes at least one conductor cable arranged in the at least one blade segment and being grounded, the conductive cage being electrically connected to the at least one conductor cable.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a plan view of one embodiment of a rotor blade having a first blade segment and a second blade segment according to the present disclosure;

FIG. 3 illustrates a perspective view of a section of one embodiment of the first blade segment according to the present disclosure;

FIG. 4 illustrates a perspective view of one embodiment of a section of the second blade segment at the chord-wise joint according to the present disclosure;

FIG. 5 illustrates an assembly of one embodiment of the rotor blade of the wind turbine having the first blade segment joined with the second blade segment according to the present disclosure;

FIG. 6 illustrates an exploded perspective view of one embodiment of the multiple supporting structures of the assembly of the rotor blade of the wind turbine according to the present disclosure;

FIG. 7 illustrates a partial, side view of an embodiment of a lightning protection system having a first conductive cage integrated with a beam structure of a rotor blade and a second conductive cage integrated with a receiving section of the rotor blade according to the present disclosure;

FIG. 8 illustrates a cross-sectional view of FIG. 7 along section line 8-8;

FIG. 9 illustrates a detailed view of an electrical connection of the lightning protection system of FIG. 7 according to the present disclosure;

FIG. 10 illustrates a partial, perspective view of the lightning protection system of FIG. 7, particularly illustrating the first conductive cage electrically connected to the second conductive cage according to the present disclosure;

FIG. 11 illustrates a partial, side view of the lightning protection system of FIG. 10;

FIG. 12 illustrates a schematic diagram of an embodiment of a first conductive cage integrated with a beam structure of a rotor blade and a second conductive cage integrated with a receiving section of the rotor blade and connected to the first conductive cage via an electrical connection according to the present disclosure;

FIG. 13 illustrates a side view of the schematic diagram of FIG. 12;

FIG. 14 illustrates a cross-sectional view of an embodiment of a beam structure of a rotor blade according to the present disclosure, particularly illustrating a conductive cage integrated with the beam structure;

FIG. 15 illustrates a cross-sectional view of an embodiment of a beam structure of a rotor blade received within a receiving section according to the present disclosure, particularly illustrating a conductive cage integrated with the receiving section; and

FIG. 16 illustrates a flow diagram of one embodiment of a method of assembling a rotor blade of a wind turbine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

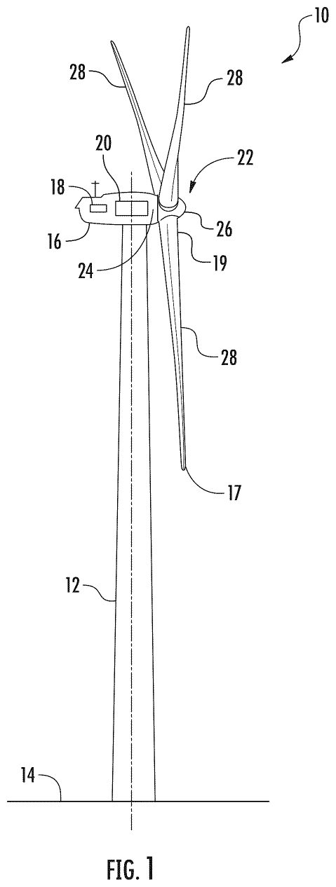

Referring now to the drawings, FIG. 1 illustrates a perspective view of one embodiment of a wind turbine 10 according to the present invention. In the illustrated embodiment, the wind turbine 10 is a horizontal-axis wind turbine. Alternatively, the wind turbine 10 may be a vertical-axis wind turbine. In addition, as shown, the wind turbine 10 may include a tower 12 that extends from a support surface 14, a nacelle 16 mounted on the tower 12, a generator 18 positioned within the nacelle 16, a gearbox 20 coupled to the generator 18, and a rotor 22 that is rotationally coupled to the gearbox 20 with a rotor shaft 24. Further, as shown, the rotor 22 includes a rotatable hub 26 and at least one rotor blade 28 coupled to and extending outward from the rotatable hub 26. As shown, the rotor blade 28 includes a blade tip 17 and a blade root 19.

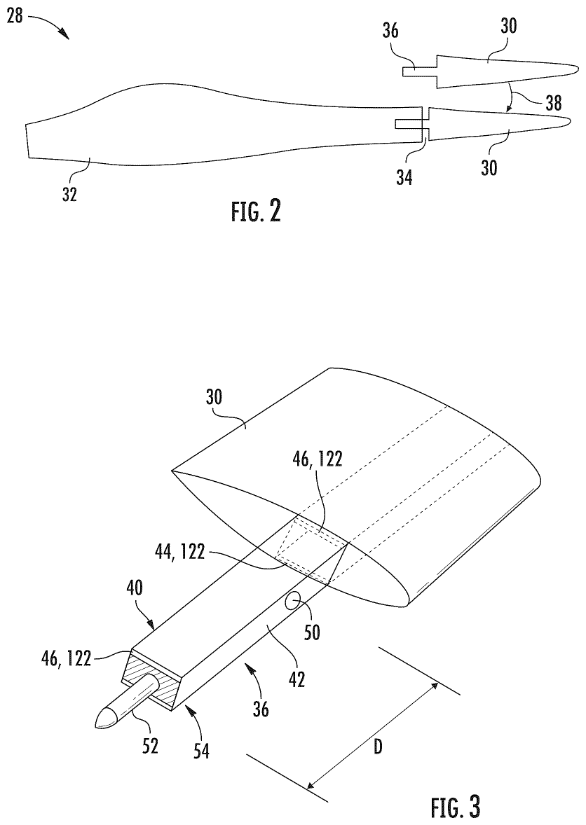

Referring now to FIG. 2, a plan view of one of the rotor blades 28 of FIG. 1 is illustrated. As shown, the rotor blade 28 may include a first blade segment 30 and a second blade segment 32. Further, as shown, the first blade segment 30 and the second blade segment 32 may each extend in opposite directions from a chord-wise joint 34. In addition, as shown, each of the blade segments 30, 32 may include at least one shell member, such as a pressure side shell member, a suction side shell member, a leading edge shell member, a trailing edge shell member and so on. The first blade segment 30 and the second blade segment 32 are connected by at least an internal support structure 36 extending into both blade segments 30, 32 to facilitate joining of the blade segments 30, 32. The arrow 38 shows that the segmented rotor blade 28 in the illustrated example includes two blade segments 30, 32 and that these blade segments 30, 32 are joined by inserting the internal support structure 36 into the second blade segment 32.

Referring now to FIG. 3, a perspective view of a section of the first blade segment 30 according to the present disclosure is illustrated. As shown, the first blade segment 30 includes a beam structure 40 that forms a portion of the internal support structure 36 and extends lengthwise for structurally connecting with the second blade segment 32. Further, as shown, the beam structure 40 forms at least a part of a shear web 42 connected with a suction side spar beam 44 and a pressure side spar beam 46 (also referred to herein as lower and upper conductive beams).

Moreover, as shown, the first blade segment 30 may include one or more first pin joints at a receiving end 54 of the beam structure 40. In one embodiment, the pin joint may include a pin that is in a tight interference fit with a bushing. More specifically, as shown, the pin joint(s) may include one pin tube 52 located on the receiving end 54 of the beam structure 40. Thus, as shown, the pin tube 52 may be oriented in a span-wise direction, i.e., along the span or length of the rotor blade 28 which is defined along an axis that extends from the blade root to the blade tip of the rotor blade 28. Further, the first blade segment 30 may also include a pin joint slot 50 located on the beam structure 40. Moreover, as shown, the pin joint slot 50 may be oriented in a chord-wise direction, i.e., along a chord of the rotor blade 28 which is defined along an axis that extends from the leading edge to the trailing edge of the rotor blade 28.

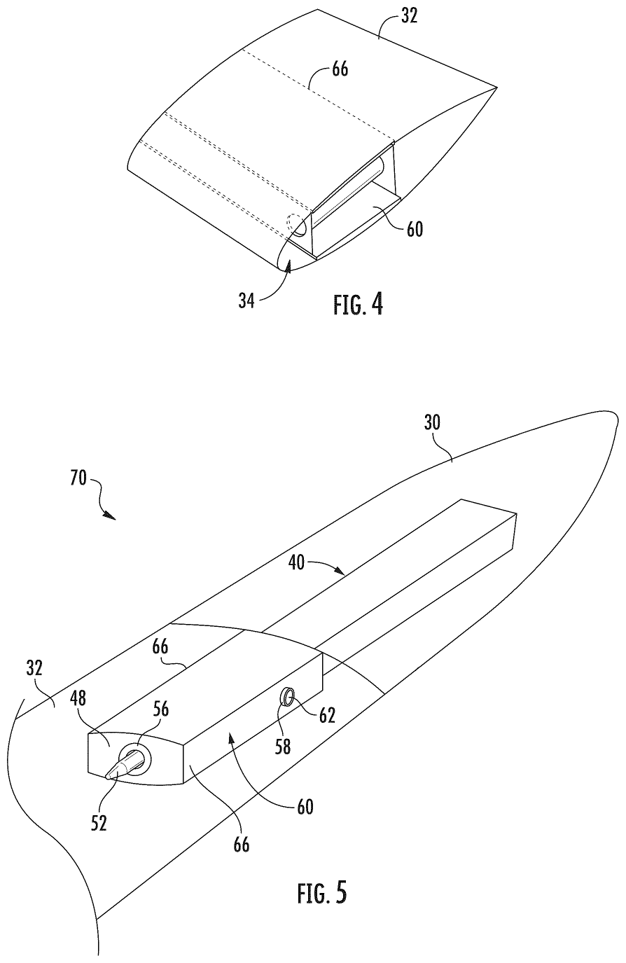

Referring now to FIG. 4, a perspective view of a section of the second blade segment 32 according to the present disclosure is illustrated. As shown, the second blade segment 32 includes a receiving section 60 extending lengthwise within the second blade segment 32 for receiving the beam structure 40 of the first blade segment 30. Further, as shown, the receiving section 60 may include the spar structures 66 that extend lengthwise for connecting with the beam structure 40 of the first blade segment 30. In addition, as shown, the receiving section 60 may include a chord-wise member 48 having a span-wise pin joint slot 56 defined therethrough. Moreover, as shown, the receiving section 60 may include a chord-wise pin joint slot 58 defined therethrough that aligns with the pin joint slot 50 of the beam structure 40.

Referring now to FIG. 5, an assembly 70 of the rotor blade 28 having the first blade segment 30 joined with the second blade segment 32 according to the present disclosure is illustrated. As shown, the assembly 70 illustrates multiple supporting structures beneath outer shell members of the rotor blade 28. More specifically, as shown, the span-wise extending pin 52 of the receiving end 54 of the beam structure 40 is received within the span-wise pin joint slot 56 of the receiving section 60 so as to secure the first and second blade segments 30, 32 together. In addition, as shown, each of the beam structure 40 and the receiving section 60 may define spar beams 44, 46, 53, 55, respectively, of the rotor blade 28.

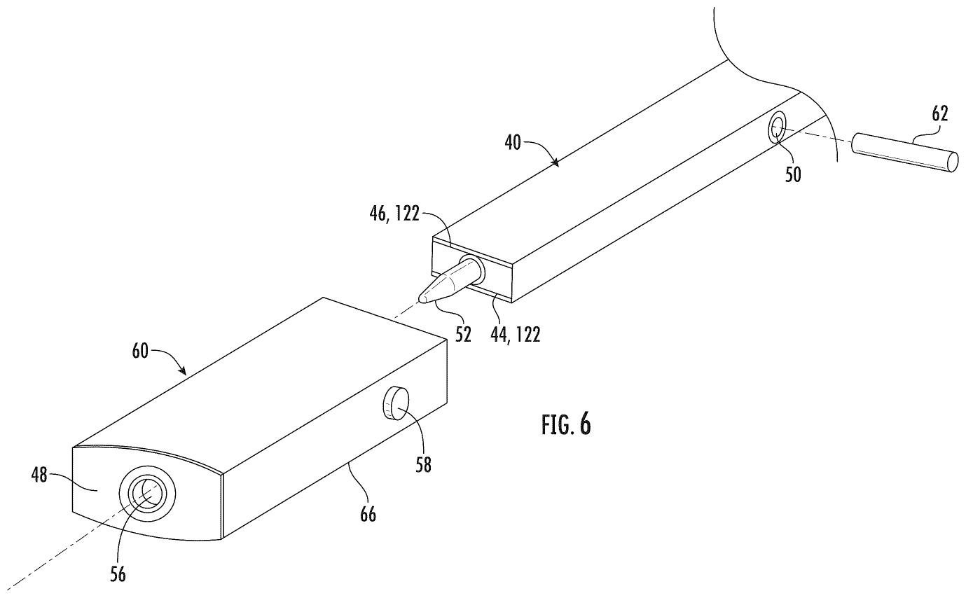

Referring now to FIG. 6, an exploded perspective view of the multiple supporting structures of the assembly 70 towards the blade tip of the rotor blade 28 is illustrated. As shown, the receiving section 60 is configured to receive the beam structure 40 and may include the chord-wise pin joint slot 58 that aligns with the pin joint slot 50 of the beam structure 40 through which a chord-wise extending pin 62 may be inserted. Further, as shown, the chord-wise extending pin 62 may be configured to remain in a tight interference fit within the aligning pin joint slots 50, 58 such that the receiving section 60 and the beam structure 40 are joined together during assembly. Further, FIG. 6 also illustrates the chord-wise member 48 that includes the pin joint slot 56 configured for receiving the pin tube 52 of the beam structure 40. As such, the pin tube 52 is configured to form a tight interference fit joint.

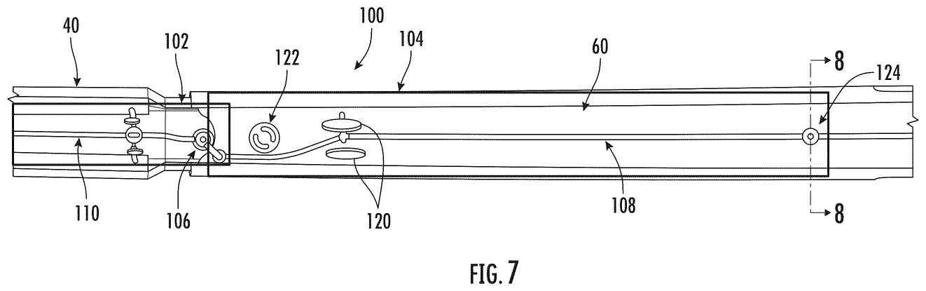

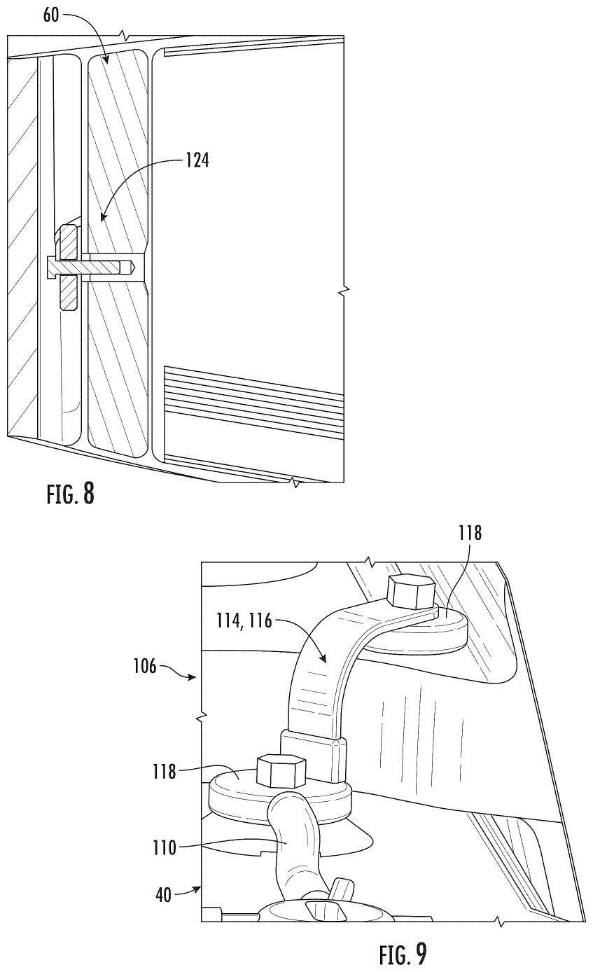

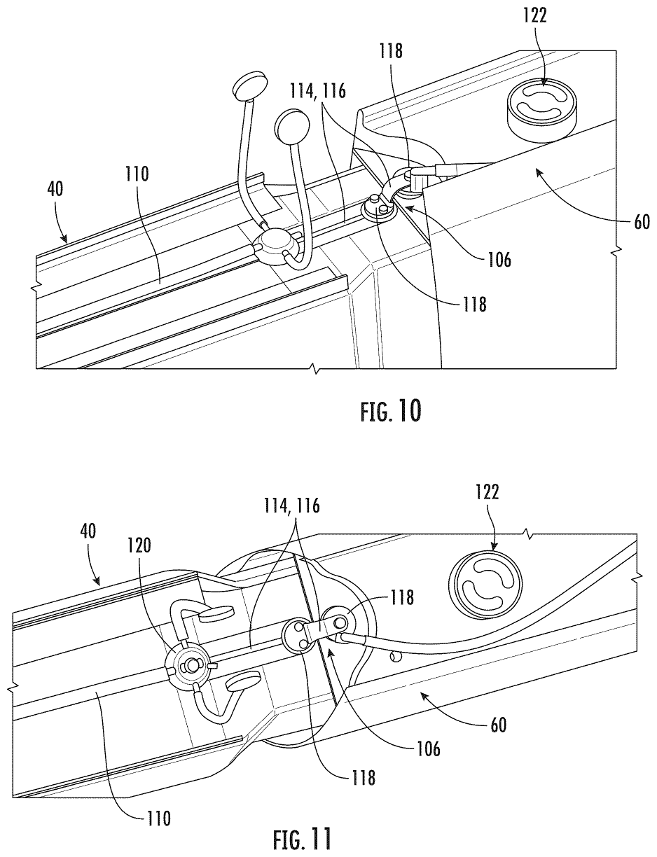

Referring now to FIGS. 7-15, various views of embodiments of a rotor blade, such as rotor blade 28, having a lightning protection system 100 according to the present disclosure are illustrated. FIG. 7 illustrates a partial, side view of the beam structure 40 connected with the receiving section 60 at the chord-wise joint 34 of the rotor blade 28. FIG. 8 illustrates a cross-sectional view of FIG. 7 along section line 8-8. FIG. 9 illustrates a detailed view of an electrical connection 106 of the lightning protection system 100 according to the present disclosure. FIG. 10 illustrates a partial, perspective view of the beam structure 40 connected with the receiving section 60 at the chord-wise joint 34 of the rotor blade 28 of FIG. 7. FIG. 11 illustrates a partial, side view of the beam structure 40 connected with the receiving section 60 at the chord-wise joint 34 of the rotor blade 28 of FIG. 7.

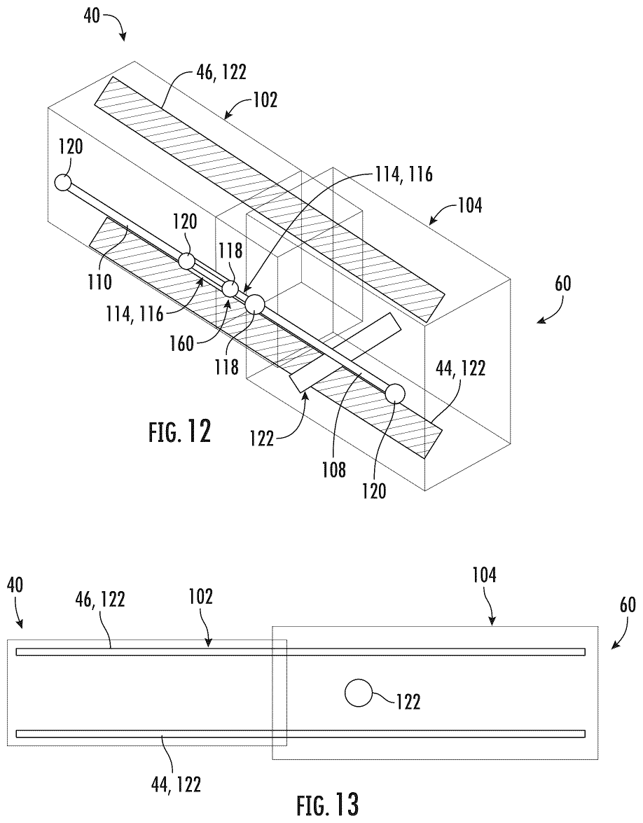

Furthermore, as shown in FIG. 7, the lightning protection system 100 may include a first conductive cage 102 integrated with the beam structure 40 and a second conductive cage 104 integrated with the receiving section 60 and electrically connected to the first conductive cage 102 via an electrical connection 106. In an embodiment, for example, the first and second conductive cages 102, 104 may act as a Faraday cage or shield. Moreover, as shown in FIGS. 12 and 13, in an embodiment, a portion of the first conductive cage 102 overlaps a portion of the second conductive cage 104. Furthermore, FIG. 12 illustrates a schematic diagram of an embodiment of the first conductive cage 102 integrated with the beam structure 40 and the second conductive cage 104 integrated with the receiving section 60 and electrically connected to the first conductive cage 102 via an electrical connection 106 according to the present disclosure. FIG. 13 illustrates a side view of the schematic diagram of FIG. 12. In such embodiments, for example, the first and second conductive cages 102, 104 may be constructed of one of a solid sheet, a wire mesh, a webbing, a netting, or a woven sheet.

Moreover, as shown in FIGS. 7 and 9, the lightning protection system 100 further includes at least one conductor cable 108, 110. For example, as shown in FIGS. 7 and 10-12, the lightning protection system 100 may include a first conductor cable 110 electrically coupled with the first conductive cage 102 and a second conductor cable 108 electrically coupled with the second conductive cage 104. Furthermore, as shown, the first conductor cable 110 is arranged with the beam structure 40 and the second conductor cable 108 is arranged with the receiving section 60. Moreover, as shown in FIGS. 7 and 9, the first and second conductor cables 108, 110 are electrically connected at the electrical connection 106. In addition, in an embodiment, the first and second conductor cables 108, 110 may be down conductors electrically connected to the first and second conductive cages 102, 104 and being grounded. For example, as shown in FIGS. 7 and 8, the first and second conductor cables 108, 110 may be grounded via an electrical connection 124. More specifically, as shown, the electrical connection 124 is configured to ground any of the conductor cables described herein.

In addition, as shown in FIG. 7, the lightning protection system 100 may include one or more lightning receptors 120 and/or one or more floating conductors 122 arranged with the beam structure 40 and/or the receiving section 60. In an embodiment, for example, the floating conductor(s) 122 may be constructed of carbon fiber reinforced polymer (CFRP) materials. More specifically, in such embodiments, the floating conductor(s) 122 may be the spar beams 44, 46. In another embodiment, for example, the floating conductor(s) 122 may be one of the pin joint(s) described herein and thus may be constructed of metal. Furthermore, in an embodiment, the first and second conductor cables 108, 110 may be electrically connected to each of the one or more lightning receptors 120 and thus, the lightning receptors 120 are grounded. In contrast, however, the floating conductors 122 are not electrically connected to the first and second conductor cables 108, 110 and are thus not grounded. As floating conductors constructed of CFRP materials can be difficult to ground and floating conductors are sometimes in limited accessibility areas of the rotor blade (for which establishing a grounding connection is complicated), the present disclosure provides the benefit of not having to ground such conductors by using the conductive cages described herein.

In further embodiments, as shown particularly in FIGS. 12 and 13, the first conductive cage 102 and/or the second conductive cage 104 surrounds the floating conductor(s) 122. Thus, in an embodiment, the first conductive cage 102 and/or the second conductive cage 104 is configured to generate an electric field therein to reduce a potential difference between the down conductor and the floating conductor(s) 122. As such, the first and second conductive cages 102, 104, the first and second conductor cables 108, 110, the lightning receptor(s) 120, and/or the floating conductor(s) 122 are configured to function to control the electric field caused by a lightning strike.

In such embodiments, the conductive components described herein (such as the first and second conductive cages 102, 104, the first and second conductor cables 108, 110, the lightning receptor(s) 120, and/or the floating conductor(s) 122, etc.) may be any suitable conductive material, e.g., such as copper. Furthermore, such conductive components may have different thicknesses and/or shapes as needed to assist with the lightning current.

Referring particularly to FIGS. 7 and 9, the electrical connection 106 may include at least one flexible connector 114 electrically connecting the first and second conductor cables 108, 110 together. For example, in an embodiment, the flexible connector(s) 114 may be a flexible circuit, a flexible braided circuit, a flexible bus bar, a flexible cable, a flexible bar stock, a flexible layered stack, or a flexible rail. In a particular embodiment, as shown in FIG. 9, the flexible connector 114 may be, for example, a flexible braided circuit 116 connected between the first and second conductor cables 108, 110. Moreover, as shown, the flexible braided circuit 116 may be secured to ends of each of the first and second conductor cables 108, 110 using, for example, one or more conductive fasteners 118 secured to the beam structure 40 and the receiving section 60, respectively. In further embodiments, the flexible braided circuit 116 may be secured to the ends of each of the first and second conductor cables 108, 110 using any suitable means, e.g., such as soldering, mechanical fasteners, adhesives, or a combination of both.

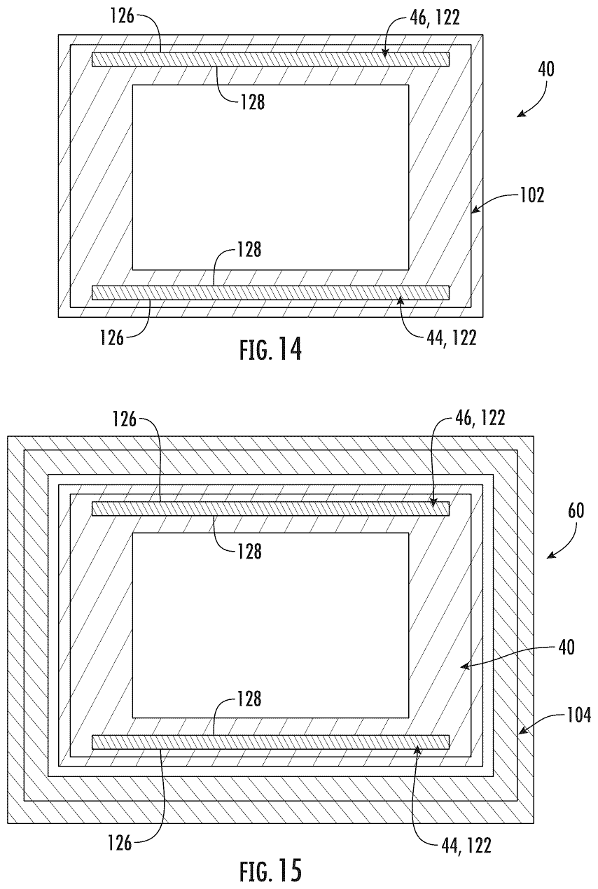

Referring now to FIGS. 14 and 15, various cross-sectional views of an embodiment of the beam structure 40 (FIG. 14) and the beam structure 40 received within the receiving section 60 (FIG. 15) are provided. In particular, as shown in FIG. 14, a conductive cage (such as the first and second conductive cages 102, 104 described herein) may be integrated into the beam structure 40. In another embodiment, as shown in FIG. 15, a conductive cage (such as the first and second conductive cages 102, 104 described herein) may be integrated into the receiving section 60. Furthermore, as shown, the beam structure 40 includes an upper conductive beam 46 and a lower conductive beam 44 integrated therein, also referred to herein as the suction side and pressure side spar beams 44, 46 and the floating conductor(s) 122. In addition, as shown, the upper and lower conductive beams 46, 44 each defining a perimeter, which generally refers to the continuous line forming the boundary of each of the suction side and pressure side spar beams 44, 46. Thus, as shown in FIGS. 14 and 15, the conductive cage(s) 102, 104 surrounds only a portion of the perimeters of each of the suction side and pressure side spar beams 44, 46. In other words, as shown, the conductive cage(s) 102, 104 extend around outer surfaces 126 of the suction side and pressure side spar beams 44, 46, but not around inner surfaces 128 of the suction side and pressure side spar beams 44, 46.

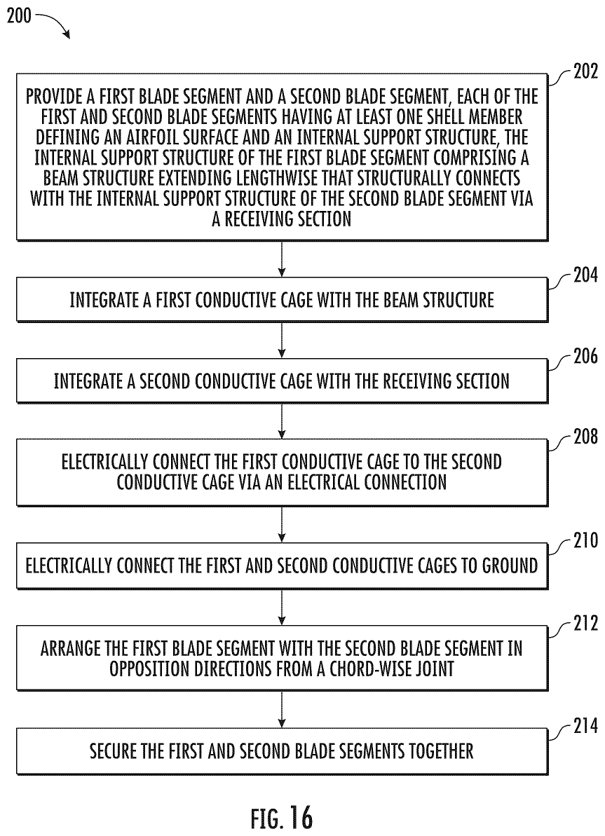

Referring now to FIG. 16, a flow diagram of one embodiment of a method 200 of assembling a rotor blade of a wind turbine is illustrated in accordance with aspects of the present disclosure. In general, the method 200 will be described herein as being implemented using a wind turbine, such as the wind turbine 10 described herein. However, it should be appreciated that the disclosed method 200 may be implemented using any other wind turbine having any lightning protection system. In addition, although FIG. 16 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes providing a first blade segment and a second blade segment. As mentioned, each of the first and second blade segments have at least one shell member defining an airfoil surface and an internal support structure. Furthermore, as mentioned, the internal support structure of the first blade segment may include a beam structure extending lengthwise that structurally connects with the internal support structure of the second blade segment via a receiving section. As shown at (204), the method 200 includes integrating a first conductive cage with the beam structure. As shown at (206), the method 200 includes integrating a second conductive cage with the receiving section. As shown at (208), the method 200 includes electrically connecting the first conductive cage to the second conductive cage via an electrical connection. As shown at (210), the method 200 includes electrically connecting a down conductor to the first and second conductive cages and to ground. As shown at (212), the method 200 includes arranging the first blade segment with the second blade segment in opposite directions from a chord-wise joint. As shown at (214), the method 200 includes securing the first and second blade segments together.

Various aspects and embodiments of the present disclosure are defined by the following numbered clauses:

A rotor blade assembly, comprising: a first blade segment and a second blade segment extending in opposite directions from a chord-wise joint, each of the first and second blade segments comprising at least one shell member defining an airfoil surface and an internal support structure, the internal support structure of the first blade segment comprising a beam structure extending lengthwise that structurally connects with the internal support structure of the second blade segment via a receiving section; and a lightning protection system, comprising: a first conductive cage integrated with the beam structure; and a second conductive cage integrated with the receiving section and electrically connected to the first conductive cage via an electrical connection, the first and second conductive cages being grounded.

The rotor blade assembly of any preceding clause, wherein the first and second conductive cages are grounded via at least one conductor cable.

The rotor blade assembly of any preceding clause, wherein the at least one conductor cable comprises at least one down conductor electrically connected to the first and second conductive cages.

The rotor blade assembly of any preceding clause, wherein the at least one conductor cable comprises a first conductor cable electrically coupled with the first conductive cage and a second conductor cable electrically coupled with the second conductive cage, the first and second conductor cables electrically connected at the electrical connection.

The rotor blade assembly of any preceding clause, wherein the first conductor cable is arranged with the beam structure and the second conductor cable is arranged with the receiving section.

The rotor blade assembly of any preceding clause, wherein the electrical connection further comprises at least one flexible connector electrically connecting the first and second conductor cables together, the at least one flexible connector comprising at least one of a flexible circuit, a flexible braided circuit, a flexible bus bar, a flexible cable, a flexible bar stock, a flexible layered stack, or a flexible rail.

The rotor blade assembly of any preceding clause, wherein the lightning protection system further comprises one or more lightning receptors, the first and second conductor cables being electrically connected to each of the one or more lightning receptors.

The rotor blade assembly of any preceding clause, wherein the lightning protection system comprises one or more floating conductors arranged with at least one of the beam structure or the receiving section, wherein at least one of the first conductive cage or the second conductive cage surrounds the one or more floating conductors, and wherein at least one of the first conductive cage or the second conductive cage is configured to generate an electric field therein to reduce a potential difference between the at least one conductor cable and the one or more floating conductors.

The rotor blade assembly of any preceding clause, wherein the one or more floating conductors are not electrically connected to the at least one conductor cable and thus are not grounded.

The rotor blade assembly of any preceding clause, wherein at least one of the first and second conductive cages is constructed of one of a solid sheet, a wire mesh, a webbing, a netting, or a woven sheet.

The rotor blade assembly of any preceding clause, wherein a portion of the first conductive cage overlaps a portion of the second conductive cage.

The rotor blade assembly of any preceding clause, wherein the rotor blade assembly is part of a wind turbine.

A method of assembling a rotor blade of a wind turbine, the method comprising: providing a first blade segment and a second blade segment, each of the first and second blade segments having at least one shell member defining an airfoil surface and an internal support structure, the internal support structure of the first blade segment comprising a beam structure extending lengthwise that structurally connects with the internal support structure of the second blade segment via a receiving section; integrating a first conductive cage with the beam structure; integrating a second conductive cage with the receiving section; electrically connecting the first conductive cage to the second conductive cage via an electrical connection; electrically connecting the first and second conductive cages to ground; arranging the first blade segment with the second blade segment in opposite directions from a chord-wise joint; and securing the first and second blade segments together.

A rotor blade assembly, comprising: at least one blade segment comprising at least one shell member defining an airfoil surface and an internal support structure, the internal support structure comprising a spar structure extending lengthwise, the spar structure comprising an upper conductive beam and a lower conductive beam integrated therein, the upper and lower conductive beams each defining a perimeter; and a lightning protection system, comprising: a conductive cage integrated with the spar structure, the conductive cage surrounding only a portion of the perimeters of each of the upper and lower conductive beams; and at least one conductor cable arranged in the at least one blade segment and being grounded, the conductive cage being electrically connected to the at least one conductor cable.

The rotor blade assembly of any preceding clause, wherein the lightning protection system further comprises at least one conductor cable electrically connected to the conductive cage and the electrical connection, wherein the at least one conductor cable is arranged with the spar structure.

The rotor blade assembly of any preceding clause, wherein the electrical connection further comprises at least one flexible connector, the at least one flexible connector comprising at least one of a flexible circuit, a flexible braided circuit, a flexible bus bar, a flexible cable, a flexible bar stock, a flexible layered stack, or a flexible rail.

The rotor blade assembly of any preceding clause, wherein the lightning protection system further comprises one or more lightning receptors, the at least one conductor cable being electrically connected to each of the one or more lightning receptors.

The rotor blade assembly of any preceding clause, wherein the lightning protection system comprises one or more floating conductors arranged with spar structure, wherein the conductive cage surrounds the one or more floating conductors, and wherein the conductive cage is configured to generate an electric field therein to reduce a potential difference between the at least one conductor cable and the one or more floating conductors.

The rotor blade assembly of any preceding clause, wherein the one or more floating conductors are not electrically connected to the at least one conductor cable and thus are not grounded.

The rotor blade assembly of any preceding clause, wherein the conductive cage is constructed of one of a solid sheet, a wire mesh, a webbing, a netting, or a woven sheet.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly, comprising:
a first blade segment and a second blade segment extending in opposite directions from a chord-wise joint, each of the first and second blade segments comprising at least one shell member defining an airfoil surface and an internal support structure, the internal support structure of the first blade segment comprising a beam structure extending lengthwise that structurally connects with the internal support structure of the second blade segment via a receiving section; and
a lightning protection system, comprising:
a first conductive cage integrated with the beam structure; and
a second conductive cage integrated with the receiving section and electrically connected to the first conductive cage via an electrical connection, the first and second conductive cages being grounded.

2. The rotor blade assembly of claim 1, wherein the first and second conductive cages are grounded via at least one conductor cable.

3. The rotor blade assembly of claim 2, wherein the at least one conductor cable comprises at least one down conductor electrically connected to the first and second conductive cages.

4. The rotor blade assembly of claim 2, wherein the at least one conductor cable comprises a first conductor cable electrically coupled with the first conductive cage and a second conductor cable electrically coupled with the second conductive cage, the first and second conductor cables electrically connected at the electrical connection.

5. The rotor blade assembly of claim 4, wherein the first conductor cable is arranged with the beam structure and the second conductor cable is arranged with the receiving section.

6. The rotor blade assembly of claim 4, wherein the electrical connection further comprises at least one flexible connector electrically connecting the first and second conductor cables together, the at least one flexible connector comprising at least one of a flexible circuit, a flexible braided circuit, a flexible bus bar, a flexible cable, a flexible bar stock, a flexible layered stack, or a flexible rail.

7. The rotor blade assembly of claim 4, wherein the lightning protection system further comprises one or more lightning receptors, the first and second conductor cables being electrically connected to each of the one or more lightning receptors.

8. The rotor blade assembly of claim 2, wherein the lightning protection system comprises one or more floating conductors arranged with at least one of the beam structure or the receiving section, wherein at least one of the first conductive cage or the second conductive cage surrounds the one or more floating conductors, and wherein at least one of the first conductive cage or the second conductive cage is configured to generate an electric field therein to reduce a potential difference between the at least one conductor cable and the one or more floating conductors.

9. The rotor blade assembly of claim 8, wherein the one or more floating conductors are not electrically connected to the at least one conductor cable and thus are not grounded.

10. The rotor blade assembly of claim 1, wherein at least one of the first and second conductive cages is constructed of one of a solid sheet, a wire mesh, a webbing, a netting, or a woven sheet.

11. The rotor blade assembly of claim 1, wherein a portion of the first conductive cage overlaps a portion of the second conductive cage.

12. The rotor blade assembly of claim 1, wherein the rotor blade assembly is part of a wind turbine.

13. A method of assembling a rotor blade of a wind turbine, the method comprising:
providing a first blade segment and a second blade segment, each of the first and second blade segments having at least one shell member defining an airfoil surface and an internal support structure, the internal support structure of the first blade segment comprising a beam structure extending lengthwise that structurally connects with the internal support structure of the second blade segment via a receiving section;
integrating a first conductive cage with the beam structure;
integrating a second conductive cage with the receiving section;
electrically connecting the first conductive cage to the second conductive cage via an electrical connection;
electrically connecting the first and second conductive cages to ground;
arranging the first blade segment with the second blade segment in opposite directions from a chord-wise joint; and
securing the first and second blade segments together.

14. A rotor blade assembly, comprising:
at least one blade segment comprising at least one shell member defining an airfoil surface and an internal support structure, the internal support structure comprising a spar structure extending lengthwise, the spar structure comprising an upper conductive beam and a lower conductive beam integrated therein, the upper and lower conductive beams each defining a perimeter; and
a lightning protection system, comprising:
a conductive cage integrated with the spar structure, the conductive cage surrounding only a portion of the perimeters of each of the upper and lower conductive beams; and
at least one conductor cable arranged in the at least one blade segment and being grounded, the conductive cage being electrically connected to the at least one conductor cable.

15. The rotor blade assembly of claim 14, wherein the lightning protection system further comprises at least one conductor cable electrically connected to the conductive cage and the electrical connection, wherein the at least one conductor cable is arranged with the spar structure.

16. The rotor blade assembly of claim 15, wherein the electrical connection further comprises at least one flexible connector, the at least one flexible connector comprising at least one of a flexible circuit, a flexible braided circuit, a flexible bus bar, a flexible cable, a flexible bar stock, a flexible layered stack, or a flexible rail.

17. The rotor blade assembly of claim 15, wherein the lightning protection system further comprises one or more lightning receptors, the at least one conductor cable being electrically connected to each of the one or more lightning receptors.

18. The rotor blade assembly of claim 14, wherein the lightning protection system comprises one or more floating conductors arranged with spar structure, wherein the conductive cage surrounds the one or more floating conductors, and wherein the conductive cage is configured to generate an electric field therein to reduce a potential difference between the at least one conductor cable and the one or more floating conductors.

19. The rotor blade assembly of claim 18, wherein the one or more floating conductors are not electrically connected to the at least one conductor cable and thus are not grounded.

20. The rotor blade assembly of claim 14, wherein the conductive cage is constructed of one of a solid sheet, a wire mesh, a webbing, a netting, or a woven sheet.
